(19) United States
(12) Patent Application Publication
(10) Pub. No.: US 2004/0020932 A1
(43) Pub. Date: Feb. 5, 2004

(54) Tubular conduit or container for transporting or storing cryogenic

(76) Inventor: Klaus Brunnhofer, Graz (AU)

Correspondence Address: BACHMAN & LAPOINTE, P.C., 900 CHAPEL STREET, SUITE 1201, NEW HAVEN, CT, 06510, US

(21) Appl. No.: 10/398,359

(22) PCT Filed: Oct. 4, 2001
(86) PCT No.: PCT/AT01/00318

(30) Foreign Application Priority Data
Oct. 4, 2000 (AT) GM7322000

(51) Int. Cl. F17C 1/00; F17C 3/00; F17C 13/00

(52) U.S. Cl. 220/560.12

(57) ABSTRACT

A pipe-like line configured according to the invention is provided for transporting or keeping cryogenic media, in particular liquefied gases, for example liquid hydrogen, and has a multi-layered construction. The connecting pieces (2, 12) required at the ends are integrated into the line by means of at least one layer (4′, 14′) of fiber-reinforced plastic.

The invention relates to a pipe-like line or container for transporting or keeping cryogenic media, in particular liquefied gases, for example liquid hydrogen, with a multi-layered construction, the line or the container having at least one layer of fiber filaments embedded in thermally cured resin and provided with at least one flange or connecting piece, which is a separate part and is sheathed on the outside by at least one layer of fiber filaments embedded in thermally cured resin. The invention also relates to a process for producing a pipe-like line or a container for transporting or keeping cryogenic media, in particular liquefied gases, for example liquid hydrogen, the line or the container being provided and using a mandrel with at least one layer of fiber filaments impregnated with thermally curable resin and being provided with at least one flange or connecting piece, which is a separate part and is sheathed on the outside by at least one layer of fiber filaments impregnated with thermally cured resin.

Hydrogen, which on account of its low molecular weight and its high gross calorific value is considered to be a fuel of the future, requires for its use in cryogenic form correspondingly heat-insulated tanks and also correspondingly heat-insulated fuel lines which can withstand the loads occurring. Tanks and fuel lines must have not only good insulating properties but also a construction that is as lightweight and compact as possible.

Various structural designs have already been proposed for storage containers or pipelines for cryogenic media. EP-A-0 465 252 discloses a container of the type stated at the beginning. This container is provided on the outside with a layer of a composite material, which is produced in such a way that a fiber filament is continuously wound and subsequently embedded in a matrix of plastic. FR-A 2 753 257 discloses a pipeline for cryogenic liquid which, considered from the inside outward, is made up of an inner pipe made of iron-nickel alloy, a thin layer of aluminum, adjoining that a layer of carbon fibers, a heat insulation of superinsulating material and an outer sheathing. GB-A 3 897 490 is likewise concerned with a system of lines for very low-temperature media, for example helium, in which an inner pipe and an outer pipe are provided, with a wire mesh in which a heat insulation comprising coated metal foils has been applied to the outer side of the inner pipe. The space between the inner pipe and outer pipe is additionally vacuum-insulated.

In the case of the known structural designs, the required connecting pieces or flanges are separately joined together with the pipelines. For this purpose, adhesive bonding or welding is used for example. The connecting points of the flanges specifically are often weak points, since, for design reasons, on the one hand the insulation is deficient here and on the other hand the forces occurring during operation, in particular torsional forces, often cannot be adequately absorbed here.

This is where the invention comes in, the object of which is to design pipelines or containers for cryogenic media and produce them by a technical process in such a way that the problems mentioned in the transitional region or connecting region with respect to flanges and the like no longer occur, at least broadly.

As far as the structural design of the pipeline or the container is concerned, the set object is achieved according to the invention by the flange or the connecting piece sitting on at least one layer of fiber filaments embedded in thermally cured resin and having been integrated in such a way into the construction of the line or the container.

As far as the process is concerned, the set object is achieved according to the invention by at least one layer of fiber filaments impregnated in thermally curable resin, on which the flange or the connecting piece is positioned, being applied to the mandrel, the flange or the connecting piece being sheathed on the outside with at least one further layer of fiber filaments impregnated in thermally curable resin, the resin being thermally cured and the mandrel being removed.

The separate subsequent connection of the flanges or the connecting pieces to the finished pipeline or the container is therefore no longer necessary, since these connecting pieces are or have been integrated into the pipeline or the container. The incorporation of the connecting pieces takes place with fiber-reinforced plastic, which is prepared from resin-impregnated fiber filaments. This allows not only an absolutely sealed connection of these parts to one another but also the required capacity for absorbing forces to be ensured.

The torsional and shearing forces occurring during operation can be absorbed particularly well if as many of the component parts or layers as possible, but at least the innermost and/or outermost layer, of the pipe-like line or the container consist of fiber-reinforced plastic (claim 2).

Lines or containers designed according to the invention are particularly stable and nevertheless also adequately flexible if the layers of fiber-reinforced plastic comprise at least one spirally wound fiber filament which is embedded in the plastic and is wound at least substantially transversely in relation to the longitudinal extent of the line or the container (claims 3 and 4).

The layer incorporating the connecting pieces has in particular a woven fabric embedded in plastic, the filaments of which are oriented at an angle of the order of 45° in relation to the longitudinal extent of the line or the container (claims 5 and 6). This ensures very good capacity for absorbing torsional forces in the otherwise very problematical transitional regions to the connecting pieces.

In the case of a preferred embodiment of the line or the container, a supporting tube or a supporting casing which is sheathed together with the connecting piece or pieces by a layer of fiber-reinforced plastic is arranged around the inner layer, at a distance from it (claim 7). This creates a structural design in which the intermediate space between the layer concerned and the supporting tube or supporting casing can be evacuated as an additional insulating measure.

In addition, annular transitional pieces, by which the distance between the supporting tube or supporting casing and the adjacent inner layer is set or maintained, may be contained between the supporting tube or the supporting casing and the connecting piece or pieces (claim 8).

For the intended uses of transporting or keeping cryogenic media, carbon or glass fibers are suitable in particular as the fibers and a resin is suitable in particular as the plastic (claims 9 and 10).

The line or the container can be produced in a simple, efficient and consequently also very cost-effective way.

In this connection, it is provided for example that the individual component parts or layers are applied step-by-step to a mandrel, which is removed after completion of the line or the container (claim 12).

In this case, a layer of a resin-impregnated fiber filament is applied directly to the mandrel as the innermost layer (claim 13). At least one further layer of resin-impregnated fiber filaments is also applied to the fiber filaments incorporating the connecting pieces (claim 14). This allows a certain flexibility to be achieved along with great strength and very good capacity for absorbing forces.

Production of the individual layers is made particularly simple if they are created by spirally winding a fiber filament which has been drawn through a resin bath, the fiber filament being wound at least substantially transversely in relation to the longitudinal extent of the line or the container (claims 15 and 16).

According to a preferred embodiment of the invention, the fiber filaments incorporating the connecting pieces are in this case a component part of a fiber fabric which is wound with a fiber filament impregnated in resin (claim 17). The fiber fabric therefore need not be separately impregnated with resin, which likewise simplifies production.

If the fiber fabric is applied in the form of a hose or flexible tube, this also makes the production process more efficient (claim 18).

For the capacity to absorb torsional forces in the region of the connecting pieces, it is of advantage in particular if the fiber fabric is applied in such a way that the filaments are oriented at an angle of the order of 45° in relation to the longitudinal extent of the line or the container (claim 19).

A separate supporting tube or a supporting casing can be positioned and incorporated in a simple way using transitional pieces during the production of the line or the container (claim 20).

In this case, to ensure a solid bond between the individual component parts, the connecting piece or pieces, the transitional piece or pieces and the supporting tube or the supporting casing are together sheathed with resin-impregnated fiber filaments (claim 21).

For the intended uses, fiber filaments of carbon fiber or glass fiber are particularly suitable (claim 22).

To ensure at least largely matching extensibility of main component parts of the line or the container, it is of advantage if the supporting tube or the supporting casing, the connecting pieces and the transitional pieces consist of the same type of fiber, in particular of carbon fiber (claim 23).

Further features, advantages and details of the invention are now described in more detail on the basis of the drawing, which contains schematic representations of exemplary embodiments of the invention and in which:

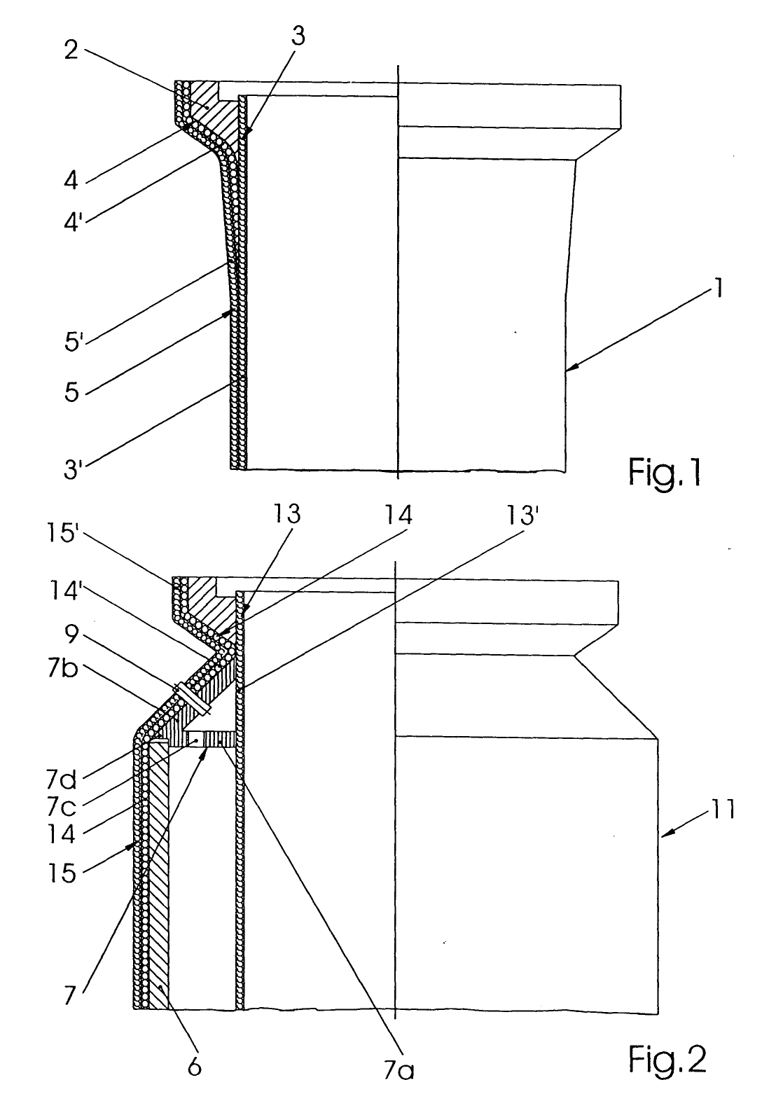

FIG. 1 shows an exemplary embodiment of a pipeline produced according to the invention and configured according to the invention with an integrated connecting piece, the left-hand half representing a longitudinal section and the right-hand half representing the view from outside, and

FIG. 2 shows a second exemplary embodiment of a pipeline in a representation analogous to FIG. 1.

Both the structural design and the production of pipelines configured according to the invention are explained below on the basis of the two exemplary embodiments represented in the figures of the drawing.

The embodiments represented concern, by way of example, pipelines of circular cross section, as can be used for instance as fuel lines for cryogenic fuel, for example liquid hydrogen, in space shuttles.

FIG. 1 shows a piece of a pipe 1 with a flange or connecting piece 2 integrated into the end region of the pipe. A further connecting piece, configured in an identical or different way, may also be provided at the second end of the pipe (not represented). The structural design of the pipe 1 and the integration of the connecting piece 2 are evident from the type of production, which is described in more detail below.

A mandrel (not shown in FIG. 1), which may for example consist of metal, is used for producing the pipe. The mandrel has an outer contour which corresponds to the inner side of the pipe 1 to be formed. The pipe 1 is built up on the mandrel from at least two layers. The innermost layer 3 is created by winding around the mandrel a carbon fiber filament 3, which during the winding operation is drawn through a resin bath in a known way. The winding operation is performed in such a way that the carbon fiber filament is wound spirally in at least one layer, so that the layer 3′ produced is closed and consequently sealed. The intended or required connecting pieces 2 are subsequently fitted onto the two end regions of the tubular layer 3′. FIG. 1 shows one of the connecting pieces 2, which is a prefabricated component, which in particular likewise consists of carbon fiber and can be produced by turning a thicker-walled carbon fiber pipe. Matching of the material—here carbon fiber—for the individual pipe layers and the connecting pieces 2 is of advantage on account of the same extensibility. The connecting pieces 2 may, however, also consist of a different material, but with a similar extensibility to that of carbon fiber.

As FIG. 1 shows, the connecting piece 2 is configured in particular in such a way that its region fitted on the end region of the pipe is provided with a tapering cross section, in order to create a largely stepless transitional region in relation to the layer 3 on the outside. A hose or a flexible tube 4 of carbon fiber fabric is pulled over the connecting piece 2 and at least also part of the layer 3′. The hose or flexible tube 4 of carbon fiber fabric is preferably pulled over the entire length of the layer 3′ and both connecting pieces 2 and is extensible at least to the extent that it can be pulled over the outer side of the connecting piece 2 and the region of the layer 3 adjacent to the latter and also makes good contact there. The individual filaments, the warp and weft threads, of which the fabric consists are oriented in the hose or flexible tube 4 in particular in such a way that they can absorb forces, torsional forces and flexural stresses particularly well in the finished pipeline. This is the case in particular with an orientation of the filaments at an angle of 45° or around 45° with respect to the longitudinal extent of the pipe 1.

A carbon fiber filament 5 which has previously been drawn through a resin bath is again wound spirally over the pulled-on or positioned hose or flexible tube 4. During the winding of the resin-impregnated carbon fiber filament 5, the hose or flexible tube 4, consisting of carbon fiber fabric, is also impregnated with resin. After completion of the outer layer 5′ by winding the carbon fiber filament 5 one or more times, the pipe 1, now finished in terms of construction, is exposed to heat in an autoclave, in order thermally to cure the resin constituents. The completed pipe 1 is finally pulled off the mandrel.

The winding of the carbon fiber filament to produce the layers 3′ and 5′ is preferably performed at a small angle of, in particular, 1 to 5° in relation to the transverse direction of the pipe 1, the individual windings being wound close together, as already mentioned.

The pipe 1 produced in this way consequently comprises two plastic layers 3′, 5′, reinforced with carbon fiber, integrated connecting pieces 2 and a further plastic layer 4′, which is reinforced with carbon fiber and incorporates the connecting pieces 2.

The second embodiment of a pipeline, represented in FIG. 2, additionally provides a double-walled construction of the pipe 11 with vacuum insulation and, if appropriate, with separate radiation protection. The production of this configurational variant is performed in a way similar to that according to FIG. 1.

As in the case of the embodiment according to FIG. 1, firstly a resin-impregnated carbon fiber filament 13 is wound onto a mandrel (not represented in FIG. 2). A prefabricated supporting tube 6 or a supporting casing, which in particular consists likewise of carbon fiber and the inside diameter of which is greater than the outside diameter of the inner layer 13′, is positioned onto the inner layer 13′ created in this way, with the aid of transitional pieces 7 at both its end regions. Each transitional piece 7 is configured as a ring which is divided into two at the center. The ring or each ring half has a base part 7a, which runs around in the form of a circular ring, and a casing 7b, which is set at an acute angle from said base part on the outer edge. The base part 7a and the casing 7b end on the inside at matching diameters, which correspond to the outside diameter of the inner layer 13′.

Formed on the outside of the base part 7a is a peripheral supporting shoulder 7d, where the end of the supporting tube 6 is supported or positioned. The base part 7a is provided with a number of holes 7c, the function of which is discussed further below. With the supporting tube 6 positioned and held by means of the transitional piece 7, sufficient space remains with respect to the free end of the inner layer 13′ for the fitting on and positioning of a connecting piece 12. A hose or flexible tube 14 of carbon fiber fabric, the configuration of which may correspond to that according to the first exemplary embodiment, is pulled over the connecting piece 12, the second connecting piece (not represented), the transitional pieces 7 and the supporting tube 6. Subsequently, an outer layer 15′ is formed by winding a resin-impregnated carbon fiber filament 15 around the hose or flexible tube 14. The resin-impregnated carbon fiber filament also soaks the pulled-on hose or flexible tube 14. After ending the winding operation, the tube 11 is finished by thermal curing of the resin and the mandrel is removed.

The completed pipe 11 therefore has, viewed from the inside outward, a construction with a carbon fiber reinforced inner plastic layer 13′ and a supporting tube 6 which is at a distance from the latter and is sheathed on the outside by two further carbon fiber reinforced layers 14′ and 15′. The connecting piece 12 is integrated into this construction by the sheathing with the layers 14′ and 15′.

As FIG. 2 shows, an insulating vacuum can be generated in the space between the supporting tube 6 and the inner layer 13′ by means of a nipple 9 subsequently introduced from outside through the casing 7b of the transitional piece 7. The holes 7c in this case establish the required connection from the interior of the transitional piece 7 to the intermediate space mentioned.

In addition, a multi-layer insulation, which in a known way comprises a number of layers, for example ten to twenty layers, of film coated with aluminum, which are insulated or separated from one another by a construction of paper or plastic, may be introduced into the intermediate space created by the supporting tube 6.

In the case of the embodiment represented and described, carbon fiber is assumed as the material for the filament to be wound and the woven fabric. Carbon fiber filaments are the preferred material on account of their physical properties. However, glass fibers or other fibers also come into consideration.

As a departure from the embodiments represented and described, it may also be provided, depending on the intended use, to dispense with the fitting-on of a hose- or flexible tube-like fabric. As an alternative to the form of a hose or flexible tube, the fabric may also be fabricated in the form of a strip and applied by winding it around. The number of layers to be wound of the impregnated fiber filament for producing the inner and outer layers depends on the internal pressure occurring during operation, so that a higher internal pressure can be absorbed by additional wound layers. Furthermore, to improve the insulating effect or to ensure the vacuum tightness, further layers, for example of metal foil, may be introduced or provided in the pipe construction. It is also possible for more than two layers of resin-impregnated and wound filament to be provided. The construction according to the invention and the process according to the invention are not restricted to the production of pipelines. In particular, cylindrically shaped containers for keeping cryogenic media may also have a construction according to the invention and be produced according to the invention.

1. A tubular line or container for transporting or keeping cryogenic media, in particular liquefied gases, for example liquid hydrogen, with a multi-layered construction, the line or the container being provided with at least one connecting piece, characterized in that the connecting piece or pieces (2, 12) is or are integrated into the line or the container by a sheathing with at least one layer (4′, 14′) of fiber-reinforced plastic.

2. The line or container as claimed in claim 1, characterized in that the innermost layer and/or the outermost layer (3′, 13′, 5′, 15′) consists or consist of fiber-reinforced plastic.

3. The line or container as claimed in claim 1 or 2, characterized in that the layers (3′, 13′, 5′, 15′) consist of fiber-reinforced plastic comprising at least one spirally wound fiber filament (3, 13, 5, 15) which is embedded in the plastic.

4. The line or container as claimed in one of claims 1 to 3, characterized in that the fiber filament is wound at least substantially transversely in relation to the longitudinal extent of the line or the container.

5. The line or container as claimed in one of claims 1 to 4, characterized in that the layer (4′, 14′) incorporating the connecting pieces (2, 12) is a woven fabric embedded in plastic.

6. The line or container as claimed in claim 5, characterized in that the filaments of the fabric are oriented at an angle of the order of 45° in relation to the longitudinal extent of the line or the container.

7. The line or container as claimed in one of claims 1 to 6, characterized in that a supporting tube (6) or a supporting casing which is sheathed together with the connecting piece or pieces (12) by a layer (14′) of fiber-reinforced plastic is arranged around an inner layer (13′), at a distance from it.

8. The line or container as claimed in one of claims 1 to 7, characterized in that annular transitional pieces (7) are contained between the supporting tube (6) or the supporting casing and the connecting piece or pieces (12).

9. The line or container as claimed in one of claims 1 to 8, characterized in that the fibers are carbon or glass fibers.

10. The line or container as claimed in one of claims 1 to 9, characterized in that the plastic is a resin.

11. A process for producing a pipe-like line of a multi-layered construction or a container of a multi-layered construction for transporting or keeping cryogenic media, in particular liquefied gases, for example liquid hydrogen, the line or the container being provided with at least one connecting piece, characterized in that the connecting piece or pieces (2, 12) are integrated in the course of production by sheathing with thermally curable resin-impregnated fiber filaments (4, 14).

12. The process as claimed in claim 11, characterized in that the individual component parts or layers are applied step-by-step to a mandrel, which is removed after completion of the line or the container.

13. The process as claimed in claim 11 or 12, characterized in that a layer of a resin-impregnated fiber filament is applied directly to the mandrel as the innermost layer.

14. The process as claimed in one of claims 11 to 13, characterized in that at least one further layer of resin-impregnated fiber filaments (5, 15) is applied to the fiber filaments (4, 14) incorporating the connecting pieces (12).

15. The process as claimed in one of claims 11 to 14, characterized in that the layers are produced by spirally winding a fiber filament (3, 13, 5, 15) which has been drawn through a resin bath.

16. The process as claimed in claim 15, characterized in that the fiber filament (3, 13, 5, 15) is wound at least substantially transversely in relation to the longitudinal extent of the line or the container.

17. The process as claimed in one of claims 11 to 13, characterized in that at least the fiber filaments incorporating the connecting pieces (2, 12) are component parts of a fiber fabric which is wound with a fiber filament (5, 15) impregnated with resin.

18. The process as claimed in claim 17, characterized in that the fiber fabric is applied in the form of a hose or flexible tube (4, 14).

19. The process as claimed in claim 17 or 18, characterized in that the fiber fabric is applied in such a way that the filaments are oriented at an angle of the order of 45° in relation to the longitudinal extent of the line or the container.

20. The process as claimed in one of claims 11 to 19, characterized in that a supporting tube (6) or a supporting casing is applied to an inner layer (13′) using transitional pieces (7).

21. The process as claimed in claim 20, characterized in that the connecting piece or pieces (12), the transitional piece or pieces (7) and the supporting tube (6) or the supporting casing are together sheathed with resin-impregnated fiber filaments.

22. The process as claimed in one of claims 11 to 21, characterized in that the fiber filaments are carbon fiber or glass fiber filaments.

23. The process as claimed in one of claims 11 to 22, characterized in that the supporting tube or the supporting casing, the connecting pieces (2, 12) and the transitional pieces (7) consist of the same type of fiber, in particular of carbon fiber.
